(19) United States
(12) Patent Application Publication
(10) Pub. No.: US 2021/0090177 A1
(43) Pub. Date: Mar. 25, 2021

(54) SYSTEM AND METHOD FOR LOSS EVALUATION

(71) Applicant: Loss Evaluator, LLC, Canton, GA (US)

(72) Inventor: Kyle Sears, Canton, GA (US)

(21) Appl. No.: 17/027,308

(22) Filed: Sep. 21, 2020

Related U.S. Application Data
(60) Provisional application No. 62/903,129, filed on Sep. 20, 2019.

(51) Int. Cl. G06Q 40/08; G06Q 50/16

(52) U.S. Cl. CPC G06Q 40/08; G06Q 50/163

(57) ABSTRACT

A system comprising a computing device is configured to at least receive a property incident data corresponding to at least one property characteristic. The system also determines initial estimated damage value based at least on one of the property incident data and an aggregated loss data. The system may also determine a relationship between the initial estimated damage value and an aggregated past damage value, and determine a refined estimated damage value based at least in part on the relationship between the initial estimated damage value and the aggregated past damage value. The system may further provide a property restoration data corresponding to at least the refined estimated damage value. An associated method and computer program product comprising at least one non-transitory computer-readable storage medium having computer-readable program instructions stored therein, the computer-readable program instructions comprising program instructions configured to cause the system to perform said associated.

### CROSS-REFERENCE TO RELATED APPLICATIONS

To the full extent permitted by law, the present United States Non-Provisional Patent Application hereby claims priority to and the full benefit of U.S. Provisional Patent Application No. 62/903,129 filed on Sep. 20, 2019, entitled “Systems and Methods of Loss Evaluators”, the disclosure of which is incorporated herein by reference in its entirety.

### BACKGROUND

The present disclosure generally relates to a system and method for determining an estimation of property loss and/or damage due to a variety of casualty events, such as fires, floods, storms, hurricanes, and/or other structural damage inducing events. Further, the system and method also relate to allocating resources accurately to mitigate structural damage during those casualty events is of great importance.

Generally, information regarding property loss from casualty events are not properly analyzed or categorized to provide for mitigation of future casualty events and/or the prevention of property loss from those casualty events, such as with the National Fire Incident Reporting System. Further, the National Fire Incident Reporting System does not verify or compare the information gathered from casualty events to provide accurate information for estimating property loss damage and/or identifying best practices to mitigate property loss. Additionally, casualty loss estimations are widely varied and may be inaccurate due to a wide variety of variables that may not be accounted. For example, estimations for property loss from a casualty event may also differ because of local, regional, national, and/or other selective area criteria. Moreover, property loss estimations can differ from one another based upon potential biases of the property loss estimator. For example, some property loss estimations are based, in a large part, on a cost per square foot value, such as for example, the International Code Counsel—Building Valuation Data formula.

Therefore, a need exists for a suitable system to provide for an accurate property loss estimation and to provide for accurate allocation of resources to mitigate further property loss from future casualty events for numerous interested parties, such as, for example, emergency responders and/or the like. Further, the need for standardizing and providing consistent valuations for damages and/or property loss also exists.

### BRIEF SUMMARY

Example implementations of the present disclosure are directed to a system that includes at least one computing device having at least one processor and at least one memory storing computer program code, wherein the at least one memory and stored computer program code are configured, with the at least one processor, to cause the computing device to at least receive a property incident data that corresponds to at least one property characteristic. The system may be further configured to cause the at least one computing device to determine an initial estimated damage value based at least on one of the property incident data and an aggregated loss data. Aggregated loss data may correspond to a past property loss characteristic. According to some aspects, the system may be configured to cause the computing device to determine a relationship between the initial estimated damage value and an aggregated past damage value. The system may further be configured to cause the computing device to determine a refined estimated damage value based at least in part on the relationship between the initial estimated damage value and the aggregated past damage value. The system may also be configured to provide a property restoration data that corresponds to at least the refined estimated damage value.

The system may also cause the computing device to determine a saved property value based at least in part on the property incident data received by the computing device. According to some aspects of the present disclosure, the system may further be configured to cause the computing device to receive a restoration data that corresponds to at least one restored property characteristic. Another aspect of the present disclosure provides for a system configured to cause a computing device to determine a revised aggregated past damage value based at least in part on the aggregated loss data corresponding to a past property loss characteristic. According to another example aspect of the present disclosure, the system may further be configured to cause the computing device to determine a fire prevention resource value based at least in part on a relationship between the refined estimated damage value and the property incident data. Additionally, the system may be configured to cause the computing device to receive property incident data that corresponds to a casualty incident characteristic.

In another aspect of the present disclosure, a system comprising at least one processor and at least one memory storing computer program code, wherein the at least one memory and stored computer code are configured, with the at least one processor, to cause the system to perform the method of receiving property incident data corresponding to at least one property characteristic, determining an initial estimated damage value based at least on one of the property incident data and an aggregated loss data, the aggregated loss data corresponding to a past property loss characteristic, determining a relationship between the initial estimated damage value and an aggregated past damage value, determining a refined estimated damage value based at least in part on the relationship between the initial estimated damage value and the aggregated past damage value, and providing a property restoration data corresponding to at least the refined estimated damage value.

In yet another aspect of exemplary embodiment, a computer program product is provided that comprises at least one non-transitory computer-readable storage medium having computer-readable program instructions stored therein, the computer-readable program instructions comprising program instructions configured to cause an apparatus to perform a method comprising receiving property incident data corresponding to at least one property characteristic, determining an initial estimated damage value based at least on one of the property incident data and an aggregated loss data, the aggregated loss data corresponding to a past property loss characteristic, determining a relationship between the initial estimated damage value and an aggregated past damage value, determining a refined estimated damage value based at least in part on the relationship between the initial estimated damage value and the aggregated past damage value, and providing a property restoration data corresponding to at least the refined estimated damage value.

The foregoing illustrative summary, as well as other exemplary objectives and/or advantages of various embodiments of the present disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 illustrates a schematic block diagram of a computing device of a system configured to provide for at least an estimation of a property value loss and/or property value saved according to one example aspect of the present disclosure;

FIG. 2 illustrates a schematic block diagram of a system configured to provide for at least an estimation of a property value loss and/or property value saved according to one example aspect of the present disclosure;

FIG. 3 illustrates a schematic block diagram of a system of steps for providing a loss evaluation according to one example aspect of the present disclosure;

FIG. 4 illustrates a fire propagation curve determined by a system according to one example aspect of the present disclosure;

FIG. 5 illustrates a graphical interface of a computing device of a system configured to provide for receiving data associated with incident property characteristics;

FIG. 5.1 illustrates a chart associated with a system configured to provide for determining an aggregated past damage value according to one example aspect of the present disclosure;

FIG. 5.2 illustrates a chart and graph associated with a system configured to provide for determining an aggregated past damage value according to one example aspect of the present disclosure;

FIGS. 5.3.1 and 5.3.2 illustrate various charts and graphs associated with a system configured to provide for determining an aggregated past damage value according to one example aspect of the present disclosure;

FIGS. 5.4.1-5.4.3 illustrate various charts and graphs associated with a system configured to provide for determining an aggregated past damage value according to one example aspect of the present disclosure;

FIG. 5.5 illustrates a graphical interface of a computing device of a system configured to provide for receiving data associated with incident property characteristics according to one example aspect of the present disclosure;

FIG. 5.6 illustrates a graphical interface of a computing device of a system configured to provide for receiving data associated with incident property characteristics according to one example aspect of the present disclosure;

FIGS. 5.7.1-5.7.5 illustrate various charts and graphs associated with a system configured to provide for determining an aggregated past damage value according to one example aspect of the present disclosure;

FIGS. 5.8.1-5.8.3 illustrate various charts associated with a system configured to provide for receiving a property incident data corresponding to at least one property characteristic according to one example aspect of the present disclosure; and

FIG. 6 a graphical interface of a computing device of a system configured to provide for at least an estimation of property value loss and/or property value saved according to one example aspect of the present disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

Some embodiments of the present disclosure will now be described more fully hereinafter with reference to the accompanying drawings, in which some, but not all embodiments of the present disclosure are shown. Indeed, the exemplary embodiments may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

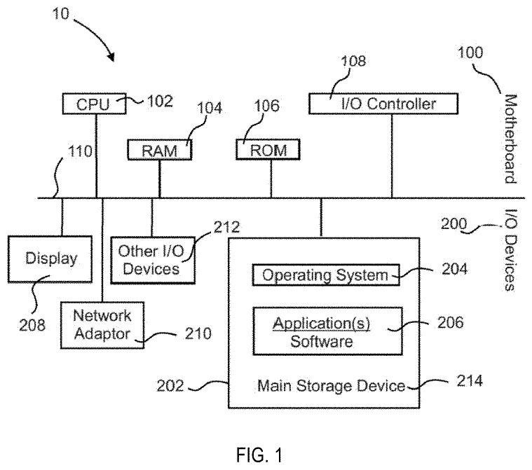

Referring now to FIG. 1, there is illustrated a block diagram of a computing device 10 that provides a suitable environment for implementing embodiments of the present disclosure. The computer architecture shown in FIG. 1 is divided into two parts—motherboard 100 and the input/output (I/O) devices 200. Motherboard 100 preferably includes subsystems and/or processor(s) to execute instructions such as central processing unit (CPU) 102, a memory device, such as random access memory (RAM) 104, input/output (I/O) controller 108, and a memory device such as read-only memory (ROM) 106, also known as firmware, which are interconnected by bus 110. A basic input output system (BIOS) containing the basic routines that help to transfer information between elements within the subsystems of the computer is preferably stored in ROM 106, or operably disposed in RAM 104. Computing device 10 further preferably includes I/O devices 202, such as main storage device 214 for storing operating system 204 and instructions or application program(s) 206, and display 208 for visual output, and other I/O devices 212 as appropriate. Main storage device 214 preferably is connected to CPU 102 through a main storage controller (represented as 108) connected to bus 110. Network adapter 210 allows the computer system to send and receive data through communication devices or any other network adapter capable of transmitting and receiving data over a communications link that is either a wired, optical, or wireless data pathway. It is recognized herein that central processing unit (CPU) 102 performs instructions, operations or commands stored in ROM 106 or RAM 104.

Processor 102 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments, processor 102 comprises a plurality of processors. The plurality of processors may be embodied on a single computing device or may be distributed across a plurality of computing devices collectively configured to function as the computing device 10. The plurality of processors may be in operative communication with each other and may be collectively configured to perform one or more functionalities of the computing device 10 as described herein. In an example embodiment, processor 102 is configured to execute instructions stored in memory 104, 106 or otherwise accessible to processor 102. These instructions, when executed by processor 102, may cause the computing device 10 to perform one or more of the functionalities of the computing device 10 as described herein.

Whether configured by hardware, firmware/software, or by a combination thereof, processor 102 may comprise an entity capable of performing operations according to embodiments of the present disclosure while configured accordingly. Thus, for example, when processor 102 is embodied as an ASIC, FPGA or the like, processor 102 may comprise specifically configured hardware for conducting one or more operations described herein. As another example, when processor 102 is embodied as an executor of instructions, such as may be stored in memory 104, 106, the instructions may specifically configure processor 102 to perform one or more algorithms and operations described herein.

The plurality of memory components 104, 106 may be embodied on a single computing device 10 or distributed across a plurality of computing devices. In various embodiments, memory may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 104, 106 may be configured to store information, data, applications, instructions, or the like for enabling the computing device 10 to carry out various functions in accordance with example embodiments discussed herein. For example, in at least some embodiments, memory 104, 106 is configured to buffer input data for processing by processor 102. Additionally or alternatively, in at least some embodiments, memory 104, 106 may be configured to store program instructions for execution by processor 102. Memory 104, 106 may store information in the form of static and/or dynamic information. This stored information may be stored and/or used by the computing device 10 during the course of performing its functionalities.

Many other devices or subsystems or other I/O devices 212 may be connected in a similar manner, including but not limited to, devices such as microphone, speakers, flash drive, CD-ROM player, DVD player, printer, main storage device 214, such as hard drive, and/or modem each connected via an I/O adapter. Also, although preferred, it is not necessary for all of the devices shown in FIG. 1 to be present to practice the present disclosure, as discussed below. Furthermore, the devices and subsystems may be interconnected in different configurations from that shown in FIG. 1, or may be based on optical or gate arrays, or some combination of these elements that is capable of responding to and executing instructions or operations. The operation of a computer system such as that shown in FIG. 1 is readily known in the art and is not discussed in further detail in this application, so as not to overcomplicate the present discussion.

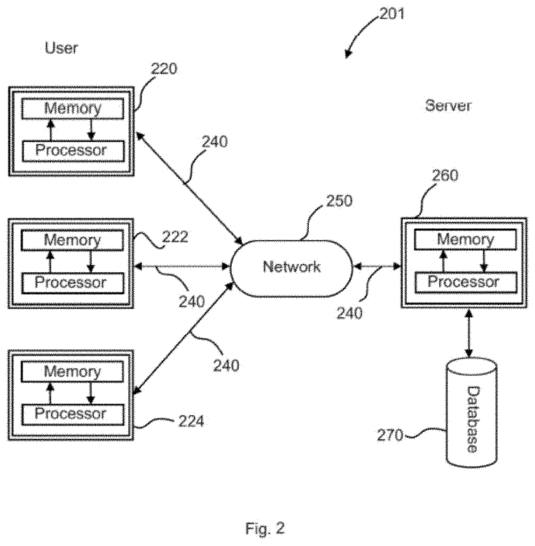

In some embodiments, some or all of the functionality of determining an accurate property loss value, an initial estimated damage value, an aggregated past damage value, a refined estimated damage value and/or a revised aggregated past damage value, and/or a fire prevention resource value may be performed by processor 102. In this regard, the example processes and algorithms discussed herein can be performed by at least one processor 102. For example, non-transitory computer readable storage media can be configured to store firmware, one or more application programs, and/or other software, which include instructions and other computer-readable program code portions that can be executed to control processors of the components of system 201, as shown in FIG. 2, to implement various operations, including the examples shown above. As such, a series of computer-readable program code portions may be embodied in one or more computer program products and can be used, with a computing device, server, and/or other programmable apparatus, to produce the machine-implemented processes discussed herein.

Any such computer program instructions and/or other type of code may be loaded onto a computer, processor or other programmable apparatuses circuitry to produce a machine, such that the computer, processor or other programmable circuitry that executes the code may be the means for implementing various functions, including those described herein.

An example embodiment of the present disclosure will now be described with reference to FIGS. 1 and 2, in which certain elements of a system 201 and/or computing device 10 may be utilized for determining an accurate property loss value, an initial estimated damage value, an aggregated past damage value, a refined estimated damage value and/or a revised aggregated past damage value, and/or a fire prevention resource value are provided. The system 201 of FIG. 2 may be employed, for example, in conjunction with the computing device 10 of FIG. 1. However, it should be noted that the computing device 10 of FIG. 1, may also be employed in connection with a variety of other devices, both mobile and fixed, and therefore, embodiments of the present disclosure should not be limited to application on devices such as the computing device 10 of FIG. 1. For example, the system 201 may be employed on a personal computer or other terminal. Moreover, in some cases, the system 201 may be on a fixed device such as a server or other service platform and the content may be presented (e.g., via a server/client relationship) on a remote device, such as a user terminal (e.g., the computing device 10) based on processing that occurs at the fixed device.

It should also be noted that while FIGS. 1 and 2 illustrates one example of a configuration of an system 201 and/or computing device 10 may be utilized for determining an accurate property loss value, an initial estimated damage value, an aggregated past damage value, a refined estimated damage value, a revised aggregated past damage value, and/or a fire prevention resource value, numerous other configurations may also be used to implement embodiments of the present disclosure. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

For example, referring now to FIG. 2, the system 201 for determining an accurate property loss value, an initial estimated damage value, an aggregated past damage value, a refined estimated damage value, a revised aggregated past damage value, and/or a fire prevention resource value is provided, and may include or otherwise be in communication with a memory and/or processor of a plurality of computing devices, such as, for example, a first, second, and third computing device 220, 222, 224. According to some aspects, the system 201 may further include a machine learning computing device 260 that may include or otherwise be in communication with a memory and/or processor of any of the first, second, and third computing devices 220, 222, 224. Although FIG. 2, illustrates a system 201 including at least a first, second, and third computing device 220, 222, 224, a system for determining an accurate property loss value, an initial estimated damage value, an aggregated past damage value, a refined estimated damage value, a revised aggregated past damage value, and/or a fire prevention resource value may include any number of computing devices.

In some embodiments, the processors (and/or co-processors or any other processing circuitry assisting or otherwise associated with the processor) may be in communication with the memory devices via a bus for passing information among components of the system 201. The memory devices may include, for example, one or more volatile and/or non-volatile memories. In other words, for example, a memory device of a first computing device 220 may be an electronic storage device (e.g., a computer readable storage medium) comprising gates configured to store data (e.g., bits) that may be retrievable by a machine (e.g., a computing device like the processor of the first computing device 220). The memory device may be configured to store information, data, applications, instructions or the like for enabling the apparatus to carry out various functions in accordance with an example embodiment of the present disclosure. For example, the memory device could be configured to buffer input data for processing by the processor of the first computing device 220. Additionally or alternatively, the memory device could be configured to store instructions for execution by the processor of the first computing device 220.

The system 201 may, in some embodiments, be a mobile terminal (e.g., computing device 10 of FIG. 1) or a fixed communication device or computing device configured to employ an example embodiment of the present disclosure. However, in some embodiments, the system 201 may be embodied as a chip or chip set. In other words, the system 201 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The system 201 may therefore, in some cases, be configured to implement an embodiment of the present disclosure on a single chip or as a single “system on a chip.” As such, in some cases, a chip or chipset may constitute means for performing one or more operations for providing the functionalities described herein.

The processors of the first, second, third computing devices 220, 222, 224 and/or the machine learning computing device 260 may be embodied in a number of different ways. For example, the processors may be embodied as one or more of various hardware processing means such as a co-processor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processors may include one or more processing cores configured to perform independently. A multi-core processor may enable multiprocessing within a single physical package. Additionally or alternatively, the processors may include one or more processors configured in tandem via the bus to enable independent execution of instructions, pipelining and/or multithreading.

In an example embodiment, the processors of the first, second, third computing devices 220, 222, 224 and/or the machine learning computing device 260 may be configured to execute instructions stored in the memory devices or otherwise accessible to the processors. Alternatively or additionally, the processors may be configured to execute hard coded functionality. As such, whether configured by hardware or software methods, or by a combination thereof, the processors may represent an entity (e.g., physically embodied in circuitry) capable of performing operations according to an embodiment of the present disclosure while configured accordingly. Thus, for example, when the processors is embodied as an ASIC, FPGA or the like, the processors may be specifically configured hardware for conducting the operations described herein. Alternatively, as another example, when the processors are embodied as an executor of software instructions, the instructions may specifically configure the processors to perform the algorithms and/or operations described herein when the instructions are executed. However, in some cases, the processors may be a processor of a specific device (e.g., a mobile terminal or other computing device), such as processor 102 of computing device 10 of FIG. 1, adapted for employing an embodiment of the present disclosure by further configuration of the processors by instructions for performing the algorithms and/or operations described herein. The processors may include, among other things, a clock, an arithmetic logic unit (ALU) and logic gates configured to support operation of the processors.

Meanwhile, as shown in FIG. 2, the communication interface 240 may be any means such as a device or circuitry embodied in either hardware or a combination of hardware and software that is configured to receive and/or transmit data from/to a network 250 and/or any other device or module in communication with and/or within the system 201. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

The user interface may be in communication with the processor to receive an indication of a user input at the user interface and/or to cause provision of an audible, visual, mechanical or other output to the user. As such, the user interface may include, for example, a keyboard, a mouse, a joystick, a display, a touch screen(s), touch areas, soft keys, a microphone, a speaker, a camera, LIDAR, and/or other input/output mechanisms. Alternatively or additionally, the processors may comprise user interface circuitry configured to control at least some functions of one or more elements of the user interface, such as, for example, a speaker, ringer, microphone, display, camera, LIDAR, and/or other input/output mechanisms and the like. The processor and/or user interface circuitry comprising the processor may be configured to control one or more functions of one or more elements of the user interface through computer program instructions (e.g., software and/or firmware) stored on a memory accessible to the processor (e.g., memory device, and/or the like).

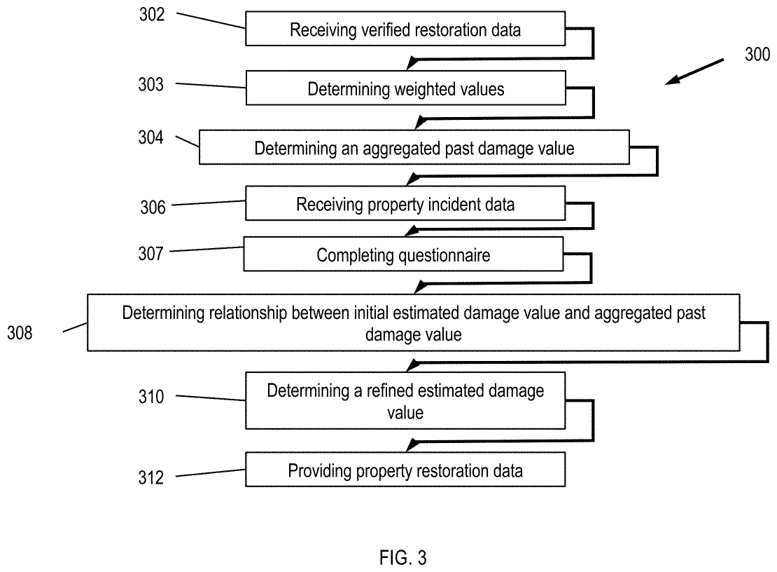

Referring now to FIG. 3, the operations performed by a system 201 and/or computing device of FIGS. 1 and 2 in accordance with one example embodiment of the present disclosure are shown. In this regard, the system 201 and/or computing device 10 may include means, such as the processor 102, the user interface provided by the display 208, and/or additional input/output devices 212 of the or the like, for providing a system of processing steps 300 of providing an accurate property loss value, an initial estimated damage value, an aggregated past damage value, a refined estimated damage value, a revised aggregated past damage value, and/or a fire prevention resource value.

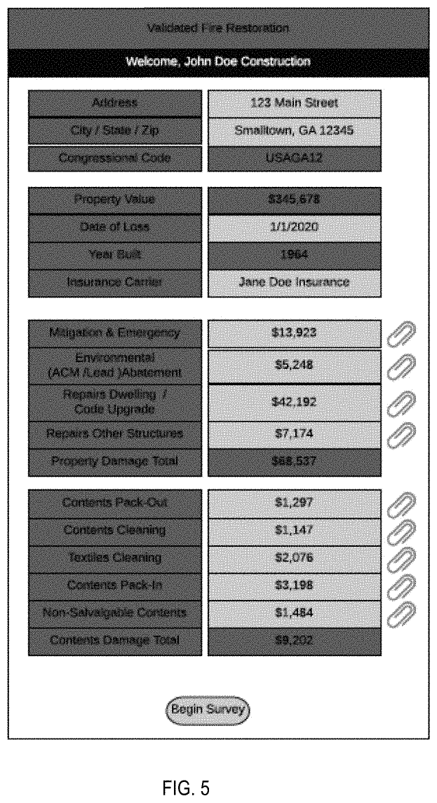

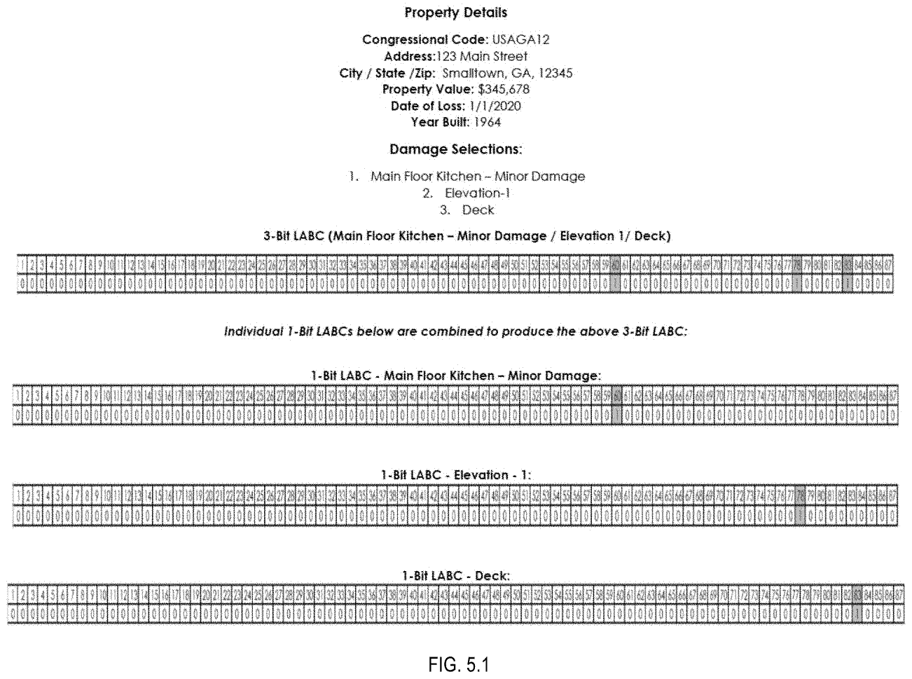

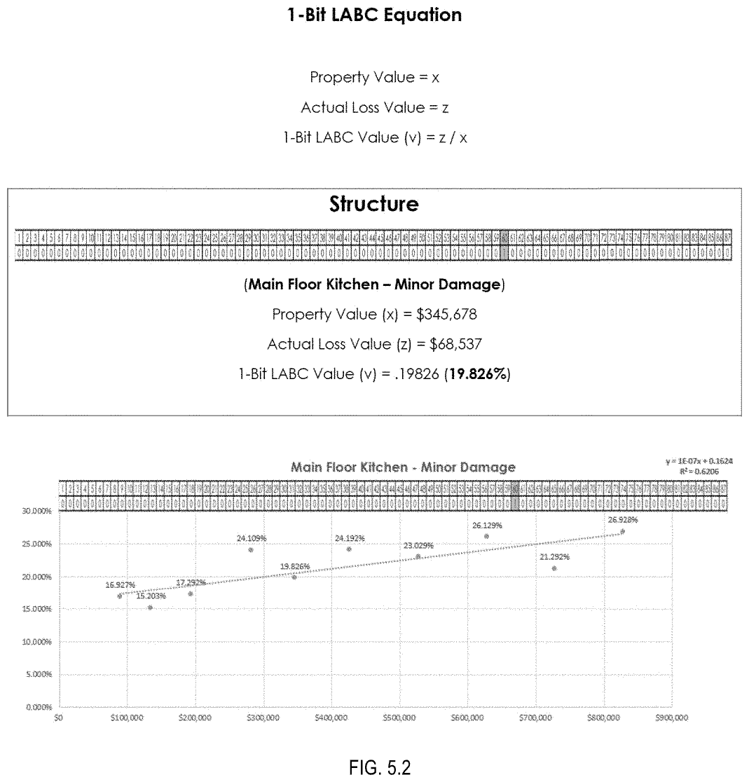

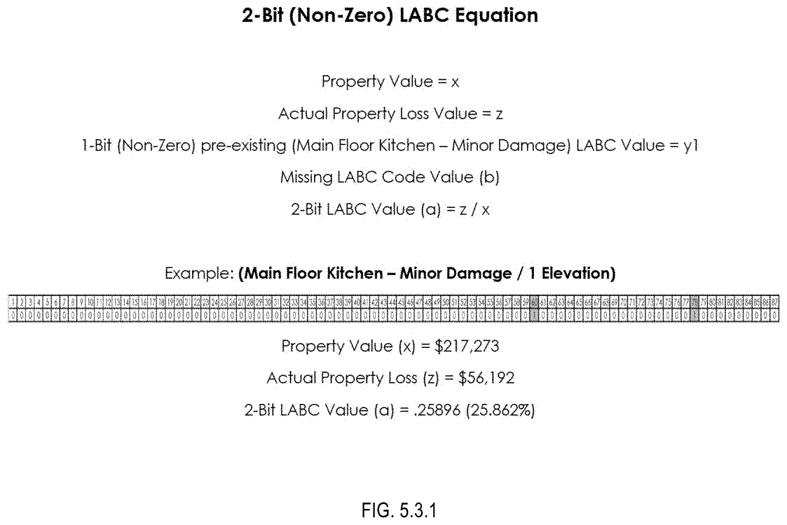

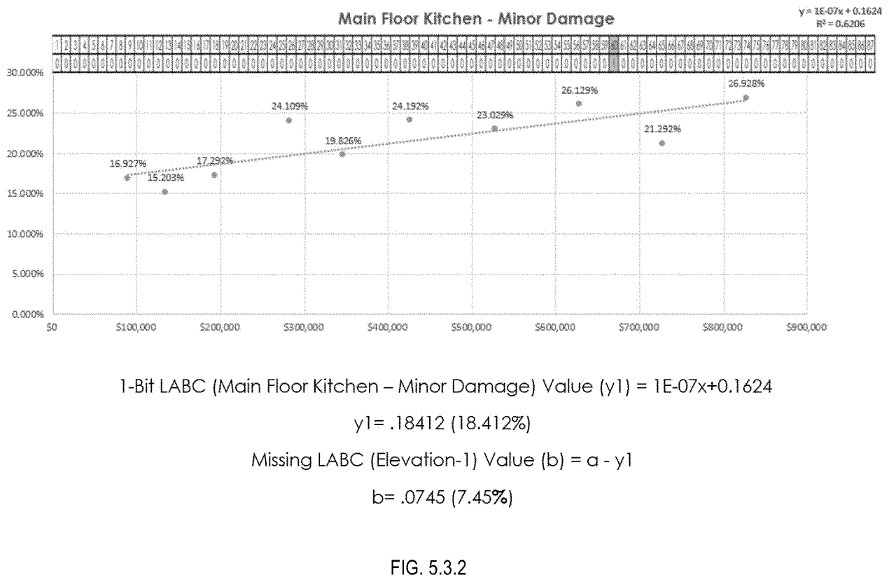

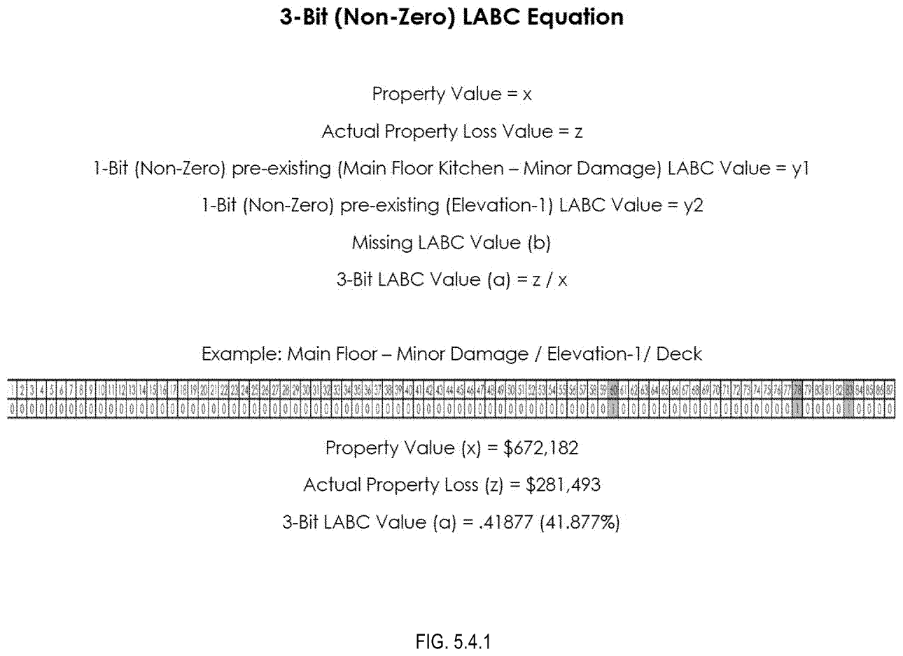

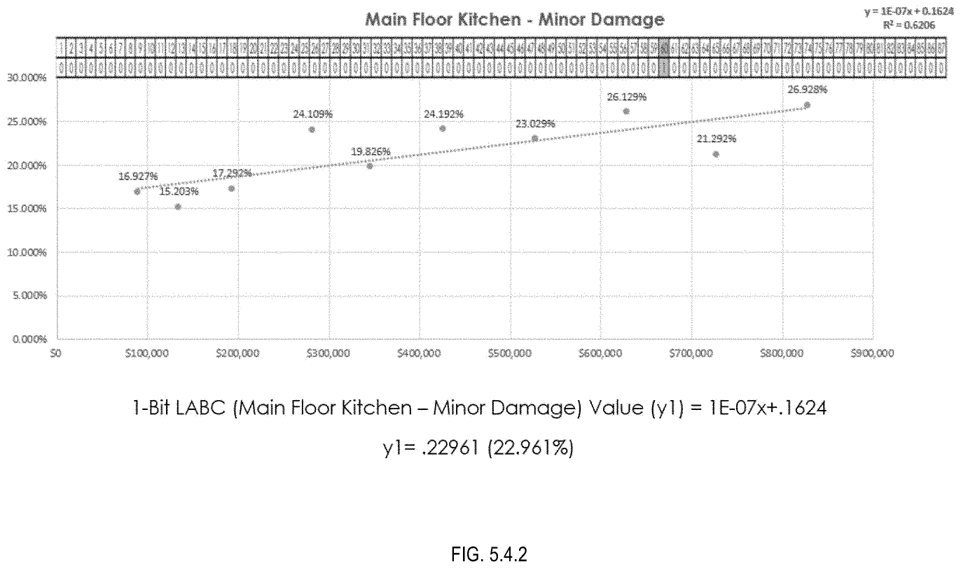

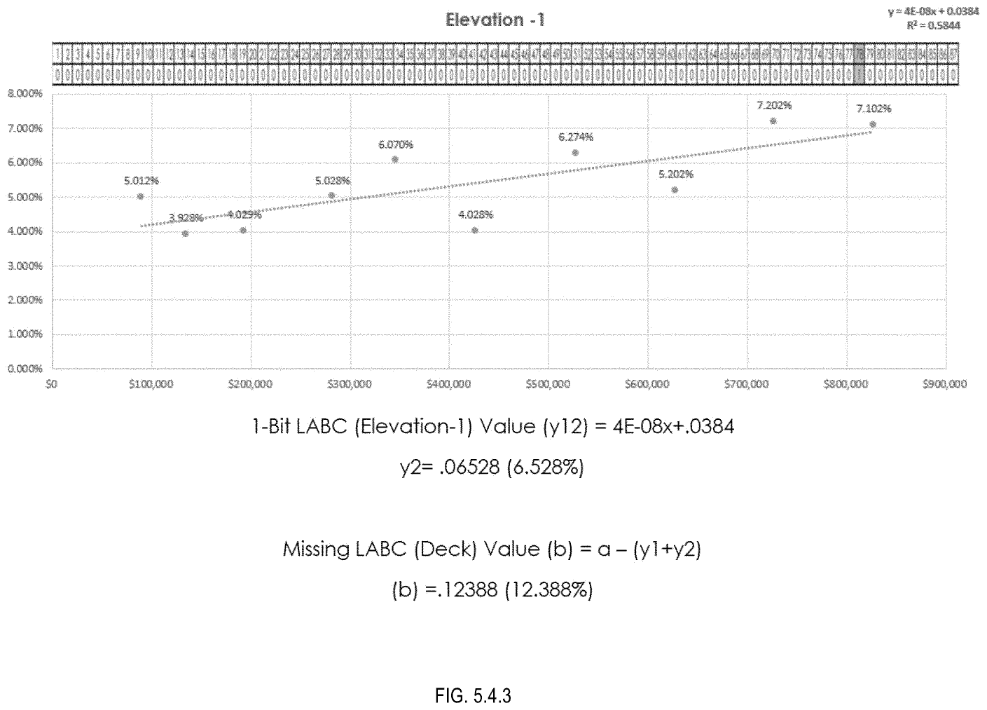

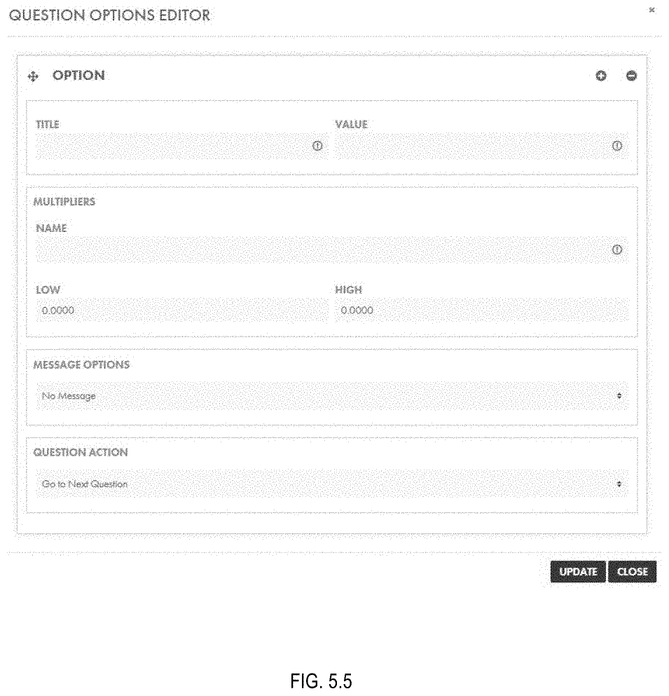

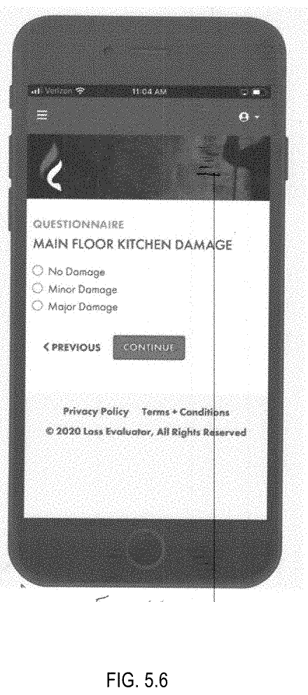

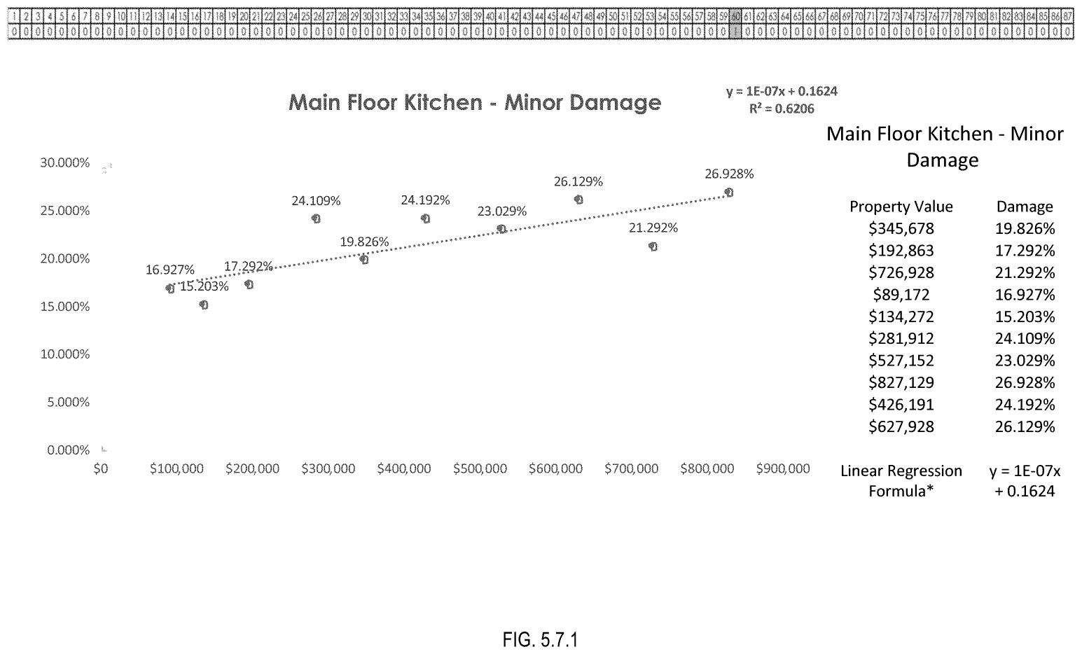

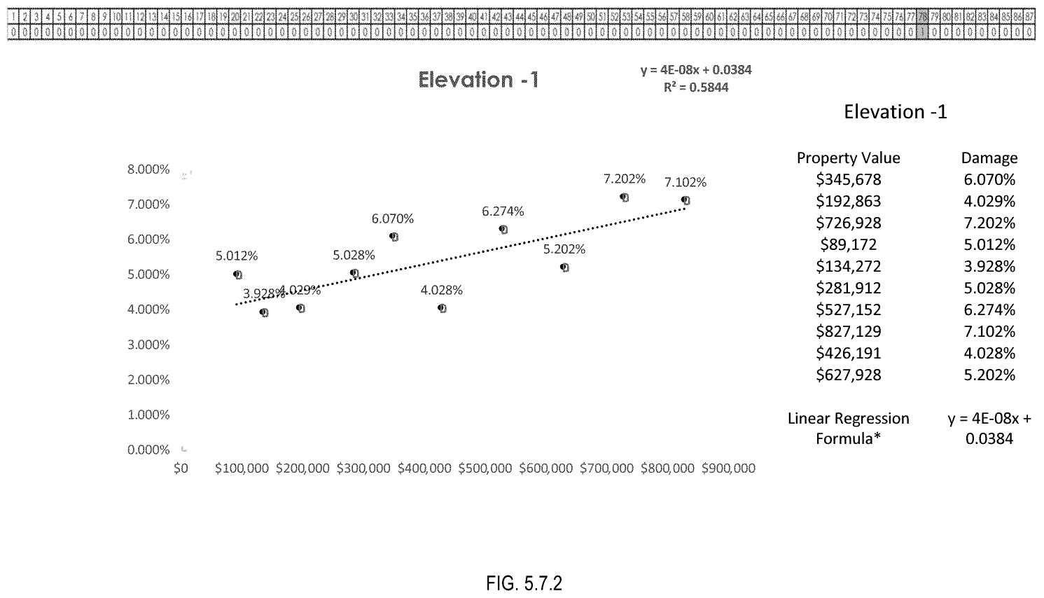

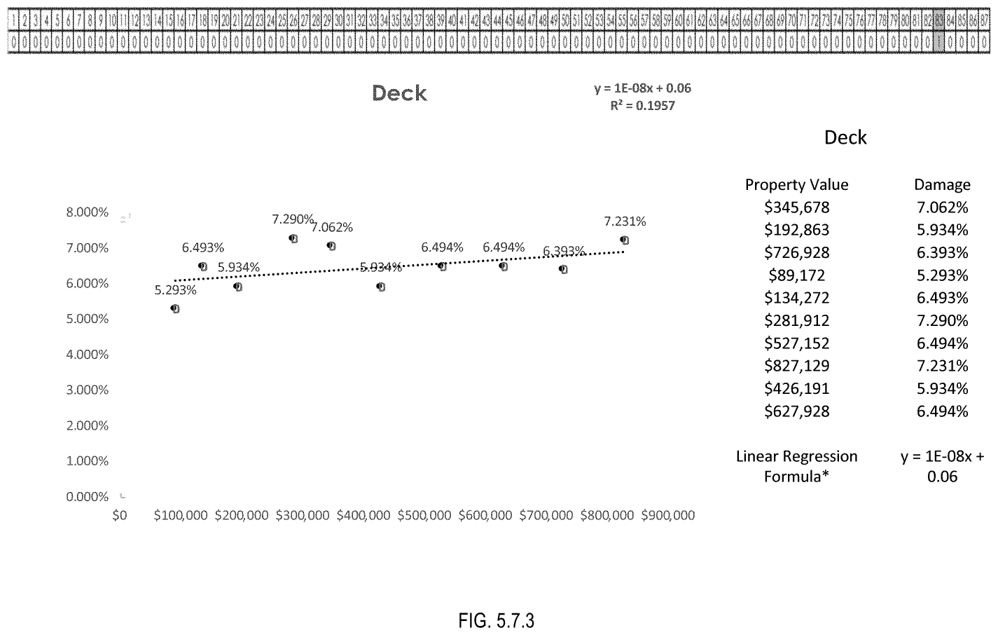

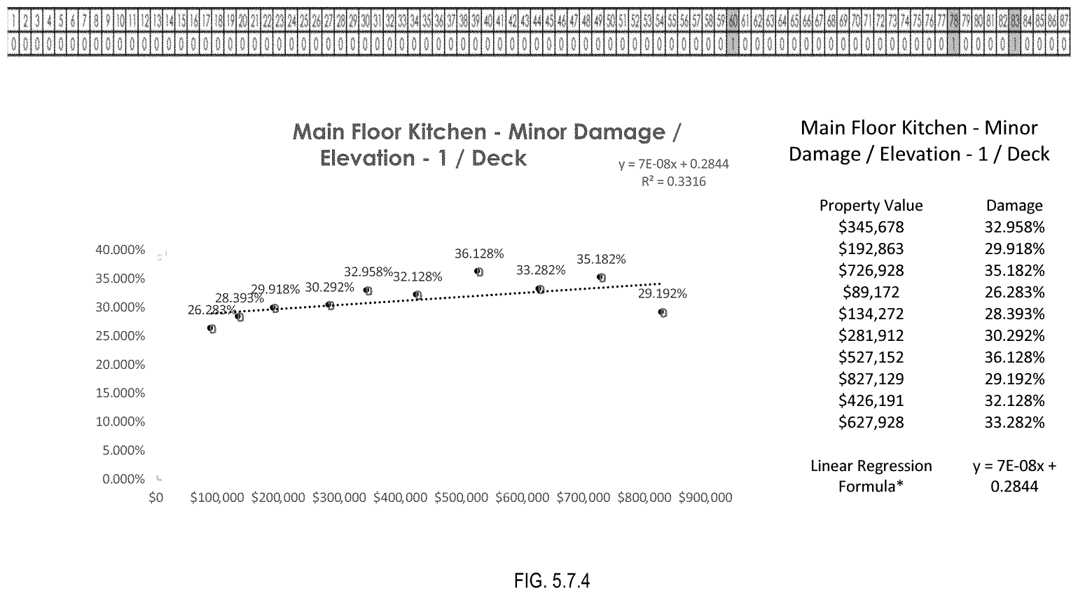

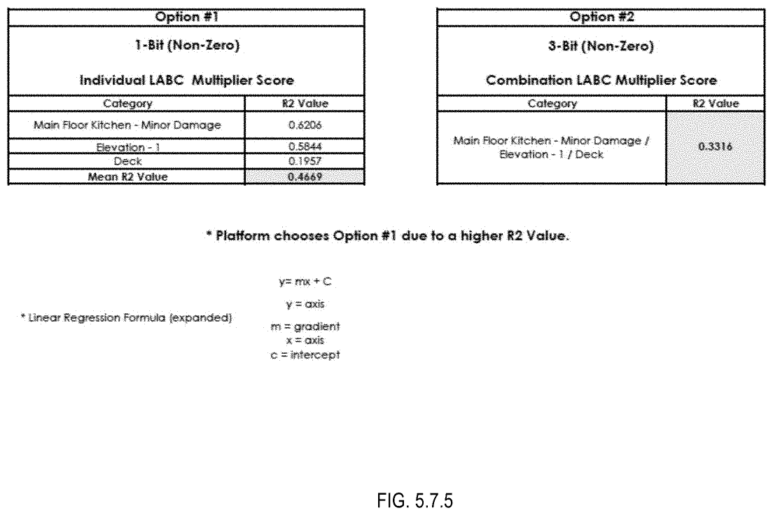

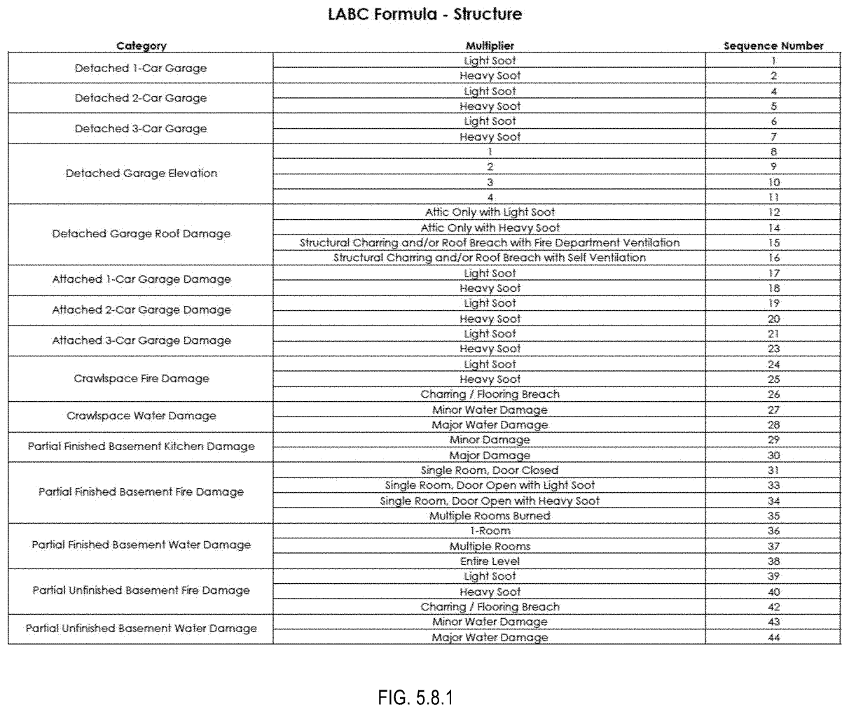

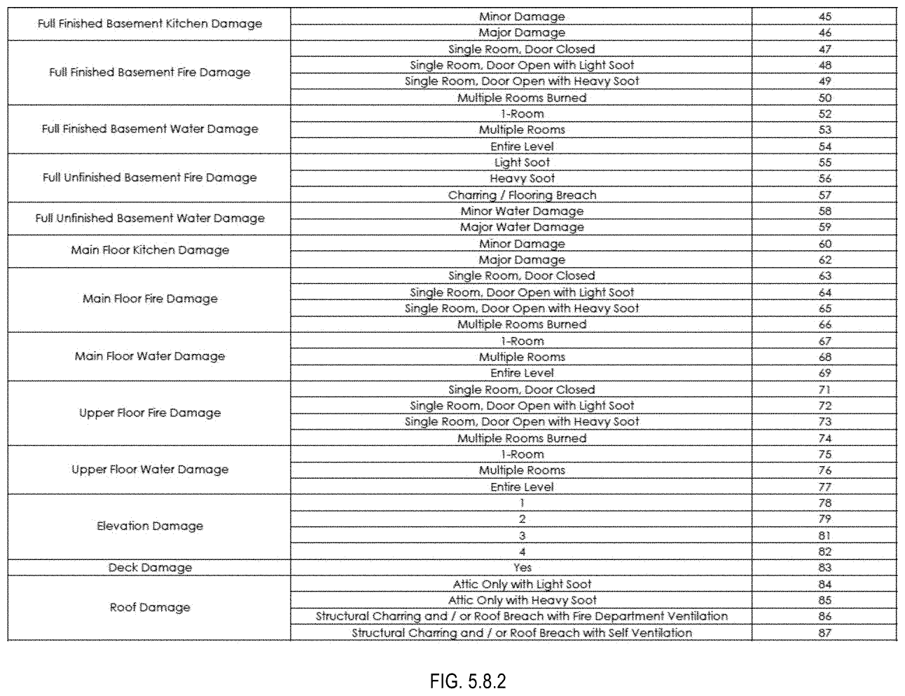

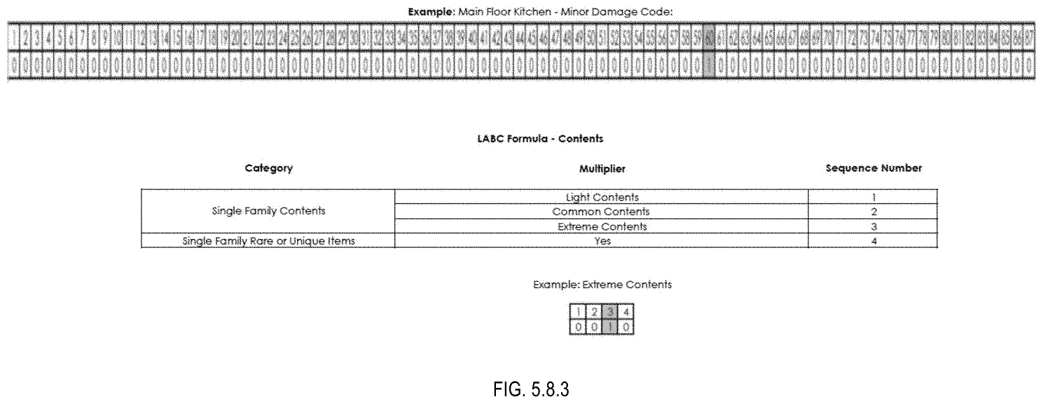

For example in operation step or block 302, a graphical user interface of a first, second, or third computing device 220, 222, 224 may be provided by the system 201 of FIG. 2 and/or computing device 10 of FIG. 1 may be utilized to collect or for collecting restoration data 302 corresponding to at least one restored property characteristic. See operation 302. In some aspects, the at least one restored property characteristic may include restoration user submission credential values so as to determine the veracity and/or accuracy of the restoration data. In some example embodiments, a certified restoration user of the system 201 of FIG. 2 may provide verified restoration data corresponding to at least one restored property characteristic. For example, as shown in FIG. 5, a graphical user interface of at least one of the first, second, and/or third computing devices 220, 222, 224, such as computing device 10 of FIG. 1 may be utilized to provide restoration data corresponding to at least one restored property characteristic, such as, the property address, the city, state, and zip code of the property, the congressional district associated with the property, the property value, the date of the property loss or casualty event, the date of construction for the property, the insurance carrier associated with the property, a mitigation and emergency cost, an environmental abatement cost, a repair cost for dwellings/code upgrade, an other structures repair cost value, a property damage total cost. Additional user inputs may correspond to a contents pack-out cost, a contents cleaning cost, a textiles cleaning cost, a contents pack-in cost, a non-salvagables contents inventory cost, and/or a contents damage total cost and other like property damage information and data. Additionally or alternatively, a graphical user interface may be provided by the system 201 and/or computing device 10 of FIGS. 1 and 2 of a first computing device 220 for collecting property incident data corresponding to at least one property characteristic and/or property incident characteristic. See operation 306 of FIG. 3.

For example in operation step or block 303, a graphical user interface of a first, second, or third computing device 220, 222, 224 may be provided by the system 201 of FIG. 2 and/or computing device 10 may be utilized to calculate or for calculating weighted values from an exemplary property detail such as Attachment D LABC Interpretation in FIG. 5.1 where 1-Bit Loss Aggregated Binary Code (LABC) may be utilized to produce or generate 3-Bit LABC weighted values for use in the following steps to calculate, adjust, and/or display an adjusted property loss range and/or value.

According to some example aspects of the present disclosure, a property characteristic, property incident characteristic, and/or restored property characteristic may include information corresponding to a particular property. For example, a property characteristic, property incident characteristic, and/or restored property characteristic may include among other things, a user identity, a reporting timestamp, a loss evaluator identification, property address, property market value, an emergency service response time value, smoke detector verification value, an occupancy value, an occupancy load value, an injury status, an injury count value, a casualty verification value, a casualty count, loss source indication, property type value, detached structure count, detached structure loss value, a mobile home loss source, a mobile home damage value, storm damage value, a percentage fire damage value, and/or the like. Additionally or alternatively, a property characteristic, property incident characteristic, and/or restored property characteristic may include information corresponding to a property's floorplan, such as the number and/or types of rooms a property includes and/or a damage value corresponding to the number and/or types of rooms damaged by the related property loss incident.

As shown in FIG. 5, a graphical user interface of a computing device provided by a system according to one example embodiment of the present disclosure may be configured to receive a user input corresponding to various property characteristics, such as, for example, a property address, a congressional district code associated with the property, a property value, a date of loss, date of construction, property insurance carrier, a mitigation and emergency cost, an environmental abatement cost, a repair cost for dwellings/code upgrade, an other structures repair cost value, a property damage total cost. Additional user inputs may correspond to a contents pack-out cost, a contents cleaning cost, a textiles cleaning cost, a contents pack-in cost, a non-salvagables contents inventory cost, and/or a contents damage total cost.

Further still, aspects of the present disclosure may provide for a method 300 that includes receiving verified restoration data and/or property incident data corresponding to image data, scanning data, and/or the like of the verified restored property and/or the property corresponding to the property incident data. As shown in FIG. 1, a computing device may include any number of I/O device 212 to provide for transmitting and/or receiving verified restoration data and/or property incident data, which may include image data, scanning data, and/or the like.

For example in operation step or block 304, a graphical user interface of a first, second, or third computing device 220, 222, 224 may be provided by the system 201 of FIG. 2 and/or computing device 10 may be utilized to determine or for determining (calculate/calculating) an aggregated past damage value based at least in part on the verified restoration data corresponding to at least one restored property characteristic. See operation 304. For example, the system 201 may include a machine learning computing device 260 configured to receive a plurality of verified restoration data and determine an aggregated past damage value based at least in part on the verified restoration data corresponding to at least one restored property characteristic. One such embodiment may include calculating 1-Bit LABC Value (v)=z/x, where Property Value=x and Actual Loss Value=z such as shown in FIG. 5.2 with 1-Bit LABC Value 0.19826=68537/345678 or 19.826%. Another such embodiment may include calculating 2-Bit (non-zero) LABC Value (a)=z/x, where Property Value=x and Actual Loss Value=z such as shown in FIG. 5.3 with 2-Bit LABC Value 0.25896=56192/217273 or 25.862%. Still further another such embodiment may include calculating 3-Bit (non-zero) LABC Value (a)=z/x, where Property Value=x and Actual Loss Value=z such as shown in FIGS. 5.4.1 and 5.4.2 with 3-Bit LABC Value 0.41877=281493/672182 or 41.877%. In some aspects, a property characteristic, property incident characteristic, and/or restored property characteristic may further include a weighted multiplier value associated with the importance of a particular property characteristic, property incident characteristic, and/or restored property characteristic. For example, a property incident characteristic may include information corresponding to the damage type and severity to various portions of the property involved in the casualty loss event. According to one example, property incident characteristics may include information associated with a single-story home with a deck having minor damage to a main floor kitchen. Determining an aggregated past damage value may further include determining past damage value estimations for a home having minor damage to a main floor kitchen, determining past damage value estimations for a home with a deck, determining past damage value estimations for a single-story home, and determining past damage value estimations for a single-story home with a deck having minor damage to a main floor kitchen.

Additionally, aspects of the present disclosure provide for a process in operation steps 300 that includes determining a relationship between an initial estimated damage value and an aggregated past damage value. See operation 308. For example, the system 201 may be configured to compare the property incident data corresponding to at least one property characteristic with an aggregated loss data, which may correspond to at least one of a past property loss characteristic. For example, aggregated loss data may include information corresponding to a past property loss characteristic. Further, the aggregated loss data may include past property incident data corresponding to at least one past property loss characteristic. For example in operation step or block 306, a graphical user interface of a first, second, or third computing device 220, 222, 224 may be provided by the system 201 of FIG. 2 and/or computing device 10 may be utilized to input for inputting multipliers low and high from operation step or block 306. One such embodiment may include input values screen such as shown in FIG. 5.5.

For example in operation step or block 307, a graphical user interface of a first, second, or third computing device 220, 222, 224 may be provided by the system 201 of FIG. 2 and/or computing device 10 may be utilized to select or for selecting (input or inputting) or completing a questionnaire to select the level of damage for a property or section of property. One such embodiment may include questionnaire screen such as shown in FIG. 5.6. For example in operation step or block 308 and 310, a graphical user interface of a first, second, or third computing device 220, 222, 224 may be provided by the system 201 of FIG. 2 and/or computing device 10 may be utilized to determine or for determining an estimated damage value on completed survey using verified aggregated past restoration data. One such embodiment may include calculating a 1-Bit LABC Multiplier Score y=Mx+C, where Main Floor Kitchen Multiplier Score may be y=1E-07x+0.1624; where Elevation Multiplier Score may be y=4E-08x+0.0384; and where Deck Multiplier Score may be y=1E-08x+0.06. Another such embodiment may include calculating a 3-Bit (non-zero) Combination Multiplier Score y=Mx+C, where Main Floor Kitchen Multiplier Score may be y=7E-08x+0.2844, such as shown in FIGS. 5.7.1 and 5.7.2. Another such embodiment may include selecting a multiplier for LABC formula as Multiplier Score, such as shown in FIG. 5.8.

According to one aspect of the present disclosure, after receiving property incident data (see operation 306/307), the system 201 may be configured to compare aggregated past damage values that include at least past damage value estimations for a past property loss characteristic that matches at least one property characteristic of the property involved in the casualty loss event. For example, in operation step or block 308, a first, second, or third computing device 220, 222, 224 may be provided by the system 201 of FIG. 2 and/or the computing device 10 of FIG. 1 may be utilized to or may be configured to compare the aggregated past damage values for a home having minor damage to a main floor kitchen, compare the aggregated past damage values for a home with a deck, compare the aggregated past damage values for a home for a single-story home, and compare the aggregated past damage values for a home for a single-story home with a deck having minor damage to a main floor kitchen with the initial estimated damage value of the property involved in the casualty loss event.

According to one aspect, the at least one past property loss characteristic may include information corresponding to at least one of a past property pre-incident valuation and a past property damage total cost value. In some aspects, the at least one past property loss characteristic may further include information corresponding to specific areas of the property that was damaged in the past and associated costs for repairing each of those specific areas of the property. For example, in operation step or block 310, first, second, or third computing device 220, 222, 224 may be provided by the system 201 of FIG. 2 and/or computing device 10 may be utilized to or may be configured to receive property incident data corresponding to a plurality of property characteristics, such as, a property being identified as a single family home, a livable square footage value, a property location, a pre-incident property value, a first damaged area, a first damage type, a first damage severity, a second damaged area, a second damage type, a second damage severity, a third damaged area, and a third damage type. Although the property incident data corresponding to a plurality of property characteristics is described herein as having a first through third damaged area, damage type, and damage severity, embodiments of the present disclosure may include any number of damaged areas, damage types, and damage severity levels.

Additionally, aspects of the present disclosure provide for operation steps 300 that includes determining a refined estimated damage value based at least in part on the relationship between the initial estimated damage value and the aggregated past damage value previously established. See operation 310. For example, a machine learning computing device 260 of the system 201 may be configured to compare a plurality of verified restoration data corresponding to at least one restored property characteristic. In one aspect, the machine learning computing device 260 may determine a regression analysis between the plurality of verified restoration data corresponding to at least one restored property characteristic. In one aspect, the system may determine a regression analysis between a plurality of verified restoration data that each corresponds to a property having a first damaged area, a first damage type, a first damage severity, a second damaged area, a second damage type, a second damage severity, a third damaged area, and a third damage type, like the property incident data that corresponds to the present incident property that has the corresponding first through third damaged areas, damage severity level, and damage type.

In one example aspect of the present disclosure, determining a refined estimated damage value based at least in part on the relationship between the initial estimated damage value and the aggregated past damage value (see Operation 310) may further include comparing the aggregated past damage values for a home having minor damage to a main floor kitchen, comparing the aggregated past damage values for a home with a deck, compare the aggregated past damage values for a home for a single-story home, and comparing the aggregated past damage values for a home for a single-story home with a deck having minor damage to a main floor kitchen with the initial estimated damage value of the property involved in the casualty loss, and/or comparing the aggregated past damage values for any combination of selected incident property characteristics for which the system has aggregated past damage values. Once the system has determined a regression analysis between the plurality of verified restoration data corresponding to at least one restored property characteristic that most accurately details the estimated damage, the system may provide property restoration data corresponding to the at least one refined estimated damage value. For example, the system may determine that property restoration data detailing the amount of damage to a single-story home having a deck and minor damage to a main floor kitchen has smaller deviations than property restoration data detailing the amount of damage to a single-story home, and/or the amount of damage to a home with a deck, and/or the amount of damage to a home having minor damage to a main floor kitchen.

According to one example embodiment, operation steps 300 for providing for an accurate property loss value, an initial estimated damage value, an aggregated past damage value, a refined estimated damage value, a revised aggregated past damage value, and/or a fire prevention resource value may further include providing a property restoration data corresponding to at least one of the refined estimated damage value. For example in operation step or block 312, a graphical user interface of a first, second, or third computing device 220, 222, 224 may be provided by the system 201 of FIG. 2 and/or computing device 10 may be utilized to display property restoration data, such as property Pre-Incident Value, Property saved value, Property Loss Range, and Recommended Loss Value as shown in FIG. 5.8. See operation 312.

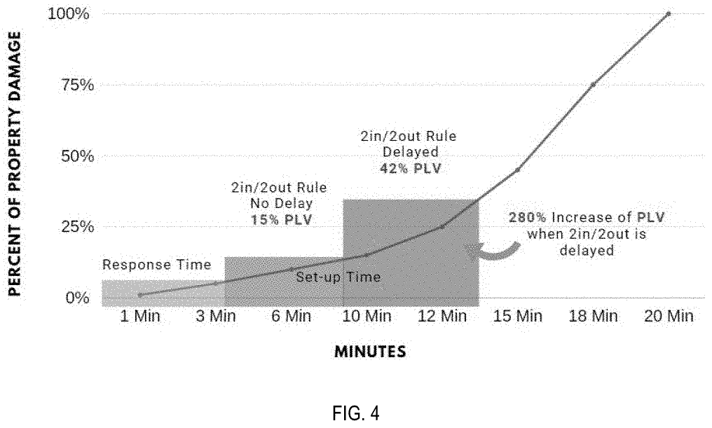

In some example embodiments of the present disclosure may provide for a system to determine a fire propagation analysis, as shown in FIG. 4. For example in operation step or block 306, a graphical user interface of a first, second, or third computing device 220, 222, 224 may be provided by the system 201 of FIG. 2 and/or computing device 10 may be utilized to input for inputting fire department's dispatch time, first engine on-scene time, and the stop loss time. One such embodiment may include input values screen similar to the one shown in FIG. 5.5. Moreover, using a weighted metric system we are able to allocate the new values of damage associated with the curve shown in FIG. 5.5. An example would be if the stop loss time on a home worth $500K is 10 minutes and it sustained 20% ($100k) damage we are able to reflect what damage has projected at different intervals based on the weighted values that were utilized in FIG. 3.

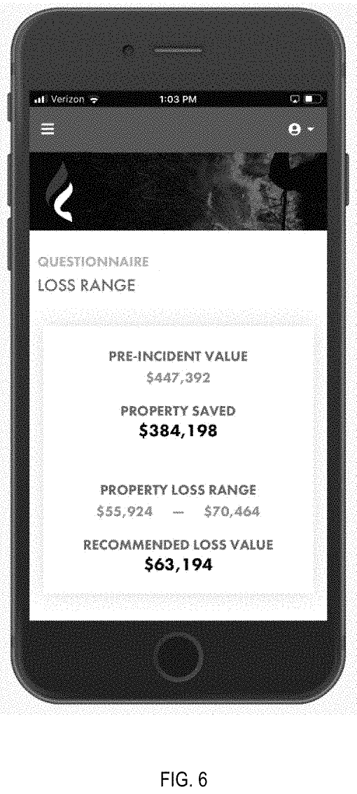

In another example aspect, the system 201 may be configured to provide property restoration data, such as, a property loss amount range and/or a recommended loss value, as shown by the graphical user interface of a computing device of the system 201, as shown in FIG. 6. For example in operation step or block 312, a graphical user interface of a first, second, or third computing device 220, 222, 224 may be provided by the system 201 of FIG. 2 and/or computing device 10 may be utilized to display property restoration data, such as property Pre-Incident Value, Property saved value, Property Loss Range, and Recommended Loss Value as shown in FIG. 6. The system 201 may be configured to provide revised aggregated loss data based at least, in part, by the property incident data received in operation step 302 in FIG. 3. Additionally, the revised aggregated loss data may include information corresponding to past property loss characteristics, such as, a percentage value of the property damaged, emergency response time, and/or confirmation of proper emergency response tactics (e.g., 2in/2out Rule).

As described above, FIG. 3 is a system according to example embodiments of the disclosure. It will be understood that each block of the operational steps, and combination of blocks in the system, may be implemented by various means, such as hardware, firmware, processor, circuitry and/or other device associated with execution of software including one or more computer program instructions. For example, one or more procedures described above may be embodied by computer program instructions. In this regard, the computer program instructions which embody the procedures described above may be stored by a memory device of a user terminal (either mobile or fixed) and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Many modifications and other embodiments of the present disclosure set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A system comprising at least one processor and at least one memory storing computer program code, wherein the at least one memory and stored computer program code are configured, with the at least one processor, to cause the system to at least:
receive a property incident data corresponding to at least one property characteristic;
determine an initial estimated damage value based at least on one of the property incident data and an aggregated loss data, the aggregated loss data corresponding to a past property loss characteristic;
determine a relationship between the initial estimated damage value and an aggregated past damage value;
determine a refined estimated damage value based at least in part on the relationship between the initial estimated damage value and the aggregated past damage value; and
provide a property restoration data corresponding to at least the refined estimated damage value.

2. A system according to claim 1, wherein the at least one memory including computer program code is configured to, with the at least one processor, cause the apparatus to determine a saved property value based at least in part on the property incident data.

3. A system according to claim 1, wherein the at least one memory including computer program code is configured to, with the at least one processor, cause the apparatus to receive a verified restoration data corresponding to at least one restored property characteristic.

4. A system according to claim 3, wherein the at least one memory including computer program code is configured to, with the at least one processor, cause the apparatus to determine a revised aggregate past damage value based at least in part on the aggregated loss data corresponding to a past property loss characteristic.

5. A system according to claim 1, wherein the at least one memory including computer program code is configured to, with the at least one processor, cause the apparatus to determine a fire prevention resource value based at least in part on a relationship between the refined estimated damage value and the property incident data.

6. A system according to claim 5, wherein the at least one memory including computer program code is configured to, with the at least one processor, cause the apparatus to receive the property incident data, wherein the property incident data corresponds to casualty incident characteristic.

7. A computer program product comprising at least one non-transitory computer-readable storage medium having computer-readable program instructions stored therein, the computer-readable program instructions comprising program instructions configured to cause a system to perform a method comprising:
receiving property incident data corresponding to at least one property characteristic;
determining an initial estimated damage value based at least on one of the property incident data and an aggregated loss data, the aggregated loss data corresponding to a past property loss characteristic;
determining a relationship between the initial estimated damage value and an aggregated past damage value;
determining a refined estimated damage value based at least in part on the relationship between the initial estimated damage value and the aggregated past damage value; and
providing a property restoration data corresponding to at least the refined estimated damage value.

8. The computer program product of claim 7 configured to cause a system to perform a method comprising determining a saved property value based at least in part on at least one of the property incident data and the property restoration data.

9. The computer program product of claim 7 configured to cause a system to perform a method comprising receiving a verified restoration data corresponding to at least one restored property characteristic.

10. The computer program product of claim 7 configured to cause a system to perform a method comprising determining a revised aggregated past damage value based at least in part on the aggregated loss data corresponding to a past property loss characteristic.

11. The computer program product of claim 7 configured to cause a system to perform a method comprising determining a fire prevention resource value based at least in part on a relationship between the refined estimated damage value and the property incident value.

12. The computer program product of claim 11 configured to cause a system to perform a method comprising receiving property incident data, wherein receiving property incident data further comprises receiving property incident data corresponding to a casualty incident characteristic.
